(19) United States
(12) Patent Application Publication
(10) Pub. No.: US 2013/0218667 A1
(43) Pub. Date: Aug. 22, 2013

(54) Systems and Methods for Intelligent Interest Data Gathering from Mobile-Web Based Applications

(71) Applicant: Moataz Ali Rashad Mohamed, (US)

(72) Inventor: Moataz Ali Rashad Mohamed, (US)

(73) Assignee: VUFIND, INC., Sunnyvale, CA (US)

(21) Appl. No.: 13/462,787

(22) Filed: May 2, 2012

Related U.S. Application Data
(60) Provisional application No. 61/633,868, filed on Feb. 21, 2012.

(51) Int. Cl. G06Q 30/02

(52) U.S. Cl. 705/14.45; 705/14.66

(57) ABSTRACT

Aspects of the present invention pertains to a system and method for targeted intelligent data gathering from web based applications through the use of mobile computing means devices. Such data is used to compile an interest profile for each mobile user, and further build an interest graph of a community of mobile users. The interest graph can further be used, but not limited to, personalization, curated experiences, as well as targeting of advertisements and commercial offers.

### RELATED AND CROSS-REFERENCED APPLICATIONS

This application claims priority from U.S. Provisional Patent Application Ser. No. 61/633,868 filed Feb. 16, 2012, which is incorporated by reference herein in its entirety for all purposes.

### FIELD OF THE INVENTION

Embodiments of the present invention generally relate to systems and methods for personalization of information displayed to mobile users, including, but not limited to, specified targeting and personalization of advertising, rewards or offers. Such personalization and targeting is based on interest profiles and interest graph of a community of users through any mobile applications or services.

### BACKGROUND

Ad targeting is commonly done using age, gender, location, and income level, collectively referred to as demographic targeting and infrequently using social graphing. However, all these approaches have failed to achieve any significant advertising engagement on mobile devices or smartphone applications. The click thru rates are lowest amongst all advertising channels due to the fact that mobile devices are designed to be personal, and thus users expect information dispensed to be personalized to their individual tastes and interests. Therefore there is a need for personalization of advertising, rewards, or offers to ensure high relevancy and user interest, resulting in clicks, redemptions, and transactions.

### SUMMARY

A method for supplying personalization and targeting profiles of users of a web-based application via a computing device comprising compiling data and activities concerning a respective community of users of said application; establishing interest profiles and interest graph for said users based on said compiled data; filtering noise and calibrating said compiled data; structuring said compiled data as a list of weighted interests; providing a weighted interest profile, wherein said weighted interest profile includes a personalization and targeting profile, based on said weighted interest list to said application; and displaying additional information to said user, wherein said additional information is based on said personalization and targeting profile.

A method for supplying personalization and targeting profiles of users of multiple web-based applications via a computing device means comprising compiling data and activities concerning a respective community of users of multiple applications all of said users who each use one common user id and all of whom share said activities to a common web-based API service; establishing interest profiles and interest graph for said users based on said compiled data; filtering noise and calibrating said compiled data; structuring said compiled data as a list of weighted interests; providing a weighted interest profile, wherein said weighted interest profile includes a personalization and targeting profile to said web-based application; and displaying additional information to said user wherein said additional information is based on said personalization and targeting profile.

A system for supplying personalization and targeting profiles of users of a mobile web-based application comprising one or more servers hosting a software method for inferring user interests based on a multiplicity of mobile user activity data, a database storing user interest attributes and interest profiles and web APIs for receiving user activity from the application server; a mobile application client running on a mobile computing device that connects with a mobile application service; and a mobile application server for said mobile application hosting its user data and user activities on said mobile application that posts such data to the targeting server.

### BRIEF DESCRIPTION OF THE DRAWINGS

Although the scope of the present invention is much broader than any particular embodiment, a detailed description of the preferred embodiment follows together with drawings. These drawings are for illustration purposes only and are not drawn to scale. Like numbers represent like features and components in the drawings. The invention may best be understood by reference to the ensuing detailed description in conjunction with the drawings in which:

FIG. 1 illustrates a diagram of an exemplary data flow diagram.

FIG. 2 illustrates a diagram of an exemplary System and Interactions of Targeting Platform with a Mobile Application.

FIG. 3 illustrates a diagram of an exemplary flowchart for computing Interests based on a user's activities on one application.

FIG. 4 illustrates a diagram of an exemplary flowchart with interests gathered from multiple applications.

FIG. 5 illustrates a diagram of an exemplary table providing mobile user activity and their associated attributes and exemplary corresponding interests.

FIG. 6 illustrates a Sample Interest Profile for a user

### DETAILED DESCRIPTION

The embodiments of the present invention are described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein. Rather, the disclosed embodiments are provided so that this disclosure will be thorough and complete, and will fully convey the scope of the invention to those skilled in the art.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In one embodiment of the present invention, a compelling commercial offer such as, but not limited to, for example, an advertisement, reward, deal, coupon, etc. targeting platform is based on the creation of an interest graph of a set of mobile users. In one exemplary embodiment, an interest graph is composed of interest indicators, such as, for example, likes, dislikes, and check-ins, to name a few. Many strong interest indicators apply to mobile users but do not exist on the web, for example check-ins, camera, and NFC (i.e., using Near Field Communications for purchases). An exemplary effective mobile interest graph targeting platform may make effective use of all these signals to provide real-time personalized analysis of the user's true interests via his or her activities on various social-web applications and platforms.

Below an exemplary system for building an interest graph of a set of mobile users, and using the exemplary interest graph to optimize an ad targeting campaign and facilitate personalized mobile commerce is described.

1. Data Collection

There are two approaches to collecting interest data: explicit and implicit. Several applications have attempted to address this by asking users to share interests explicitly with the incentive that users get more accurate recommendations in return. However, this approach has some psychological hurdles.

A user may not want to disclose to a recommendation engine that they like, for example, BMWs if the engine is only able to suggest BMW deals. For example, a user may also find it problematic to be presented with recommendations that are not relevant (e.g., car too big or too expensive) after disclosing preferences of sports cars in general. As a further example, to get more accurate recommendations, the user then has to disclose more explicit preferences (e.g., they like sports cars, but mostly European ones, and only those that are under $60K, etc.). At that point, the amount of explicit data that a user has to disclose to the engine in order to get relevant recommendation is so high that they might search for the product directly thereby rendering the recommendation engine useless. Any application where users have to take the time to populate their own interests will invariably have inaccurate or artificial interest profiles.

This is the issue social platforms such as Facebook encounter with the interest hubs; most users don't take the time to populate their profiles with accurate interests. However, even if those users that do spend the time, they still populated the subset of interests that they want to project publicly. Similarly, the social platform Google+ Sparks faces the same issues.

In one embodiment, aspects of the present invention rely on inferred interests rather than explicitly stated interests from a variety of different activities including activities such as photo and video uploads, check-ins, “likes”, and comments. Exemplary aspects of the present invention infer the interests by first analyzing the photos/videos of the users for special interests such as skiing, sailing, cycling, gardening, bird-watching, sports.

2. Noise Filtration

As a further example, every action online is considered a signal, and almost every signal in the digital world has its fair share of noise, though the noise levels and types vary greatly. For example, comments are extremely noisy (“lol”, “OMG”, “huh”, etc.). “Likes”/“+1s” are also similarly noisy when used for photos, or comments etc. However, Likes/+1 of brand fan pages for example are very reliable interest indicators.

Essentially, noise is largely correlated with the time investment/effort that goes into the activity but the degree of correlation varies depending on the person's behavioral profile. If you take the time to upload a video of yourself skiing, then that's a strong signal. If you simply Like/+1 someone's skiing photo, it may be that you like the person, or you like skiing, or you are simply trying to get the attention of the poster in order to start a conversation. Repeated check-ins at restaurants/bars are strong interest indicators as well. And clearly, reward/deal redemptions and purchases are very strong signals.

In one exemplary embodiment of the present invention, machine learning algorithms are used to detect noise patterns and spam comments, etc. Similarly, signal strengths are analyzed to determine which signals are reliable interest indicators. As an example, uploading sailboat photos every week is a different level of interest than liking a friend's sailing photo once in a while. Similarly, if a user checked in at the same sushi restaurant 6 times last months, then that's a very different signal level from one check in every 2 months. Hence, each signal in the system has multiple attributes including but not limited to frequency, strength level, noise level, etc.

Implemented within an embodiment of the present invention is a signal strengths calibration algorithm which is continually customized according to a person's behavioral pattern changes and life style taking into account seasons, locations, etc. The novel power of this design is that the engine doesn't have to “get it right” the first time, because it is modeled as a neural network and, the engine improve with usage over time.

3. The Construction of the Interest Graph

Even after the noise filtration engines for the individual signals have been well trained and continuously re-calibrated, building an interest profile for a given user, and the interest graph of a set of users still requires further processing. Essentially, the complexity is in aggregating all the signals to form a coherent and reasonably consistent interest profile.

In exemplary aspects of the present invention, each signal is correlated with as many interests as it applies to, and cross reference, and reiterate on calibration until a consistent set of interests for each user is determined.

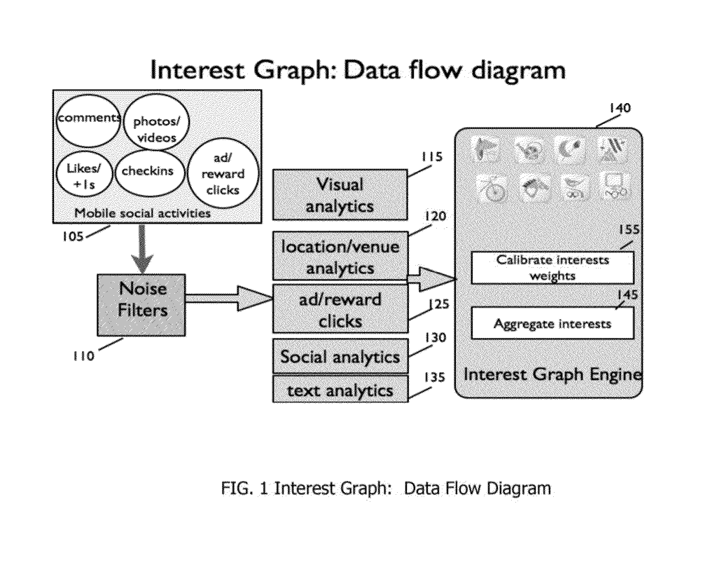

FIG. 1 depicts an exemplary interest graph platform top level data flow. The exemplary components of the system provide examples of how they interact with a given application to be used for targeting and personalization. In one embodiment, a variety of user activity signals 105 are depicted. These signals are all noisy signals. Noisy signals 103 are filtered through a noise filter 110. In one embodiment, visual analytics engine (115) analyzes photos and videos for interests based on computer vision object recognition, and AI techniques for inferring correlation between objects and interests. The engine may produce object matches. In one embodiment, these object matches may then be looked up to determine if there are one or more interest correlation in the DB Table depicted herein. In one embodiment, a location/venue analytics engine 120 analyzes the venue metadata to infer interests. In one embodiment, a reward/deal analytics engine 125 analyzes the meta-data and category of the reward/deal to infer the interests based on that, for example, spa, sushi, sports activity). In one embodiment, a textual analytics engine 130 analyzes textual comments, likes, and comments on photos/videos for sentiment, and interests. In one embodiment, a social signal analytics engine 135 merges with interest graph engine.

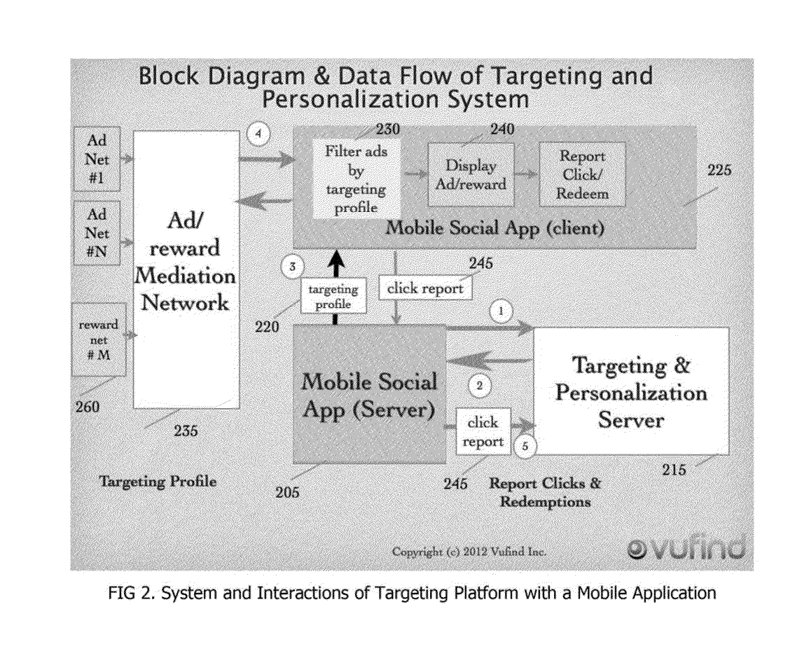

FIG. 2 depicts an exemplary system and interactions of targeting platform with a mobile application. In one embodiment, a mobile application's server 205 shares data about user's mobile activity with a personalization and targeting engine 215 via the “Put Interests Web APIs” (such data includes, for example photo uploads, video uploads, check-in, likes and comments). In one embodiment, after the personalization and targeting engine 215 collects several of these activities over a minimum specified period, the application can start making API call requesting an interest profile of the user. In one embodiment, application's server 205 sends a targeting profile 220 to the applications mobile client 225 (such as, for example, on iPhone or Android device). In one embodiment, the application uses the targeting and personalization profile 220 as a filter 230 to mask the advertisements, rewards and offers incoming to it from the ad networks 235 to ensure they are relevant to its user. In one embodiment, the application displays the advertisement, reward or offer 240 to the user, and reports the click, reward redemption, or transaction 245 to its application server 205. In one embodiment, the application server 205 reports the click, reward redemption or transaction 245 back to the targeting engine 215 to record the result this as a confirmed transaction and update the user's interest profile.

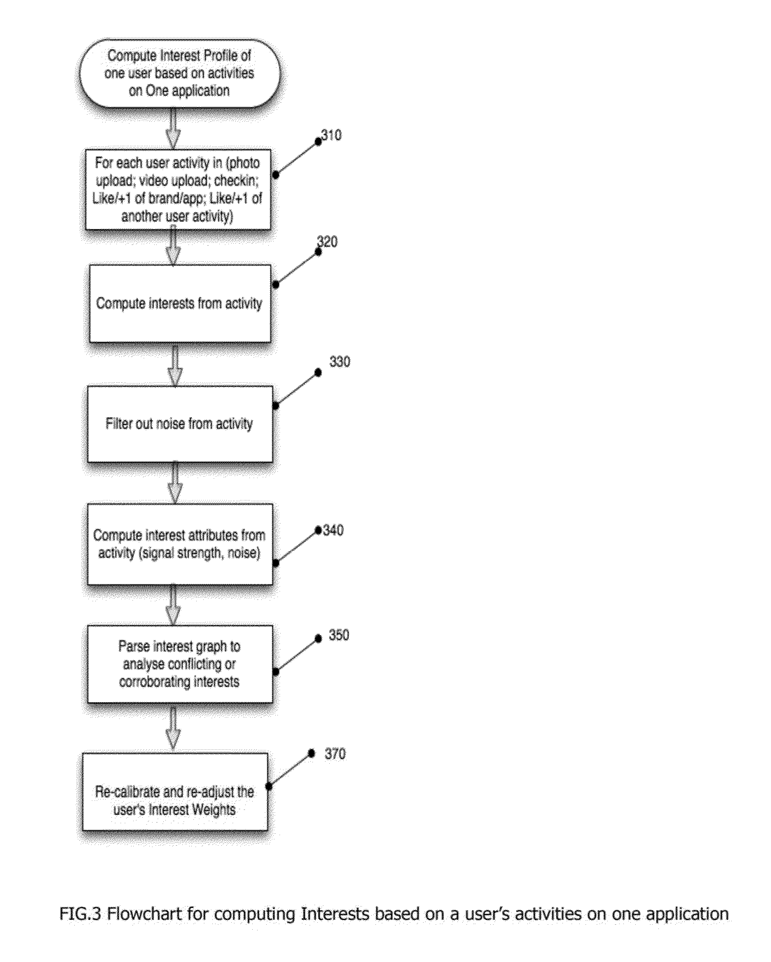

FIG. 3 illustrates an exemplary embodiment of a flowchart for computing Interests based on a user's activities on one application. In one embodiment, upon receiving an interest-indicator user activity 310 from the mobile application, the interests are extracted from said activity in 320. Said interests are run through noise filters in 330 to eliminate unreliable interests. Interest attributes are populated in 340, and then the interests are analyzed for conflicts and corroborating interests based on activity of this user and other users with similar persona to compute the initial weights in 350. Finally in 370, final calibration and adjustment of the weights in the interest profile is performed.

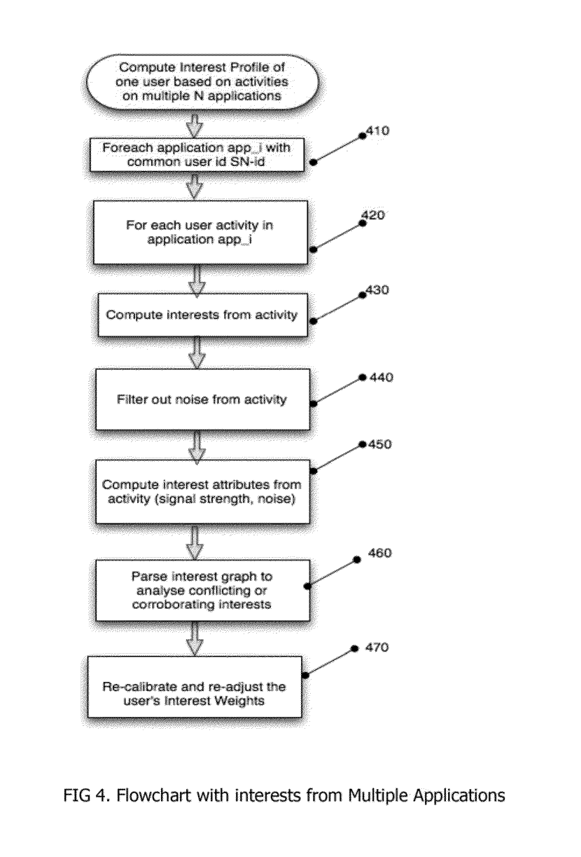

FIG. 4 illustrates an exemplary embodiment of a flowchart for computing Interests based on a user's activities on multiple applications. In one embodiment, 410 is an application amongst N applications that identifies the user via a single common social network userid. For said application, upon receiving an interest-indicator user activity 420 from the mobile application, the interests are extracted from said activity in 430. Said interests are run through noise filters in 440 to eliminate unreliable interests. These filters may do so on a single time basis, cyclically or perpetually. Interest attributes are populated in 450, and then the interests are analyzed for conflicts and corroborating interests based on activity of this user and other users with similar persona to compute the initial weights in 460. Finally in 470, final calibration and adjustment of the weights in the interest profile is performed. Although the present embodiment assumes a single common userid, it is contemplated within the scope of the embodiments of the present invention that a single user with multiple ids could also be identified and the interests could be extracted in a similar way for the single user.

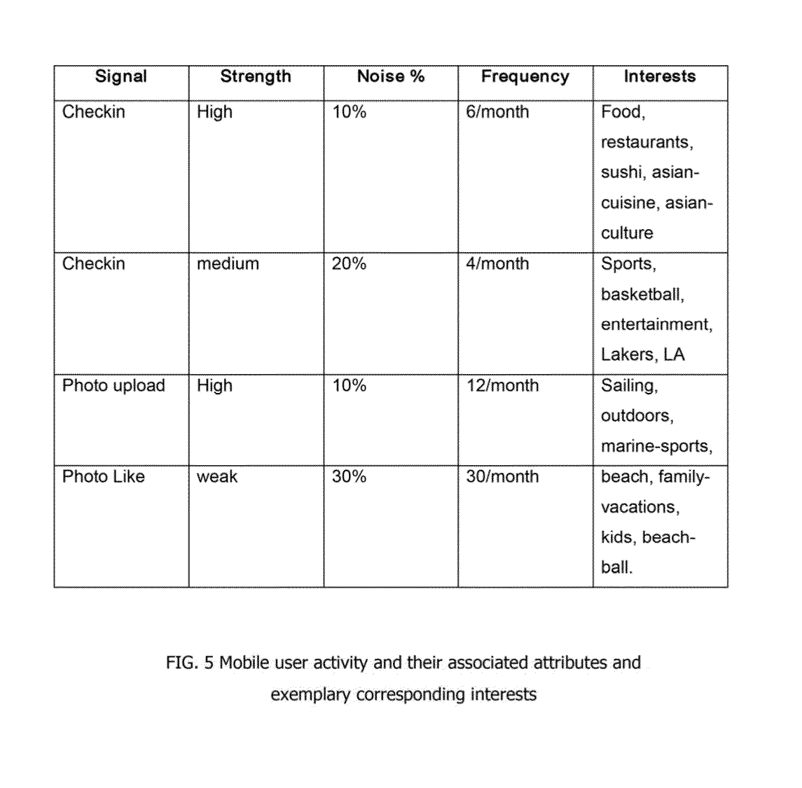

FIG. 5 illustrates an exemplary table showing sample attributes and correlation to interests. In one embodiment, a signal 505 is identified. In one embodiment, the signal's 505 strength 510 is determined. In one embodiment, the signal's 505 noise percentage 515 is assigned. In one embodiment, the signal's 505 frequency 520 is tabulated. In one embodiment, the signal's 505 interests 525 are recorded.

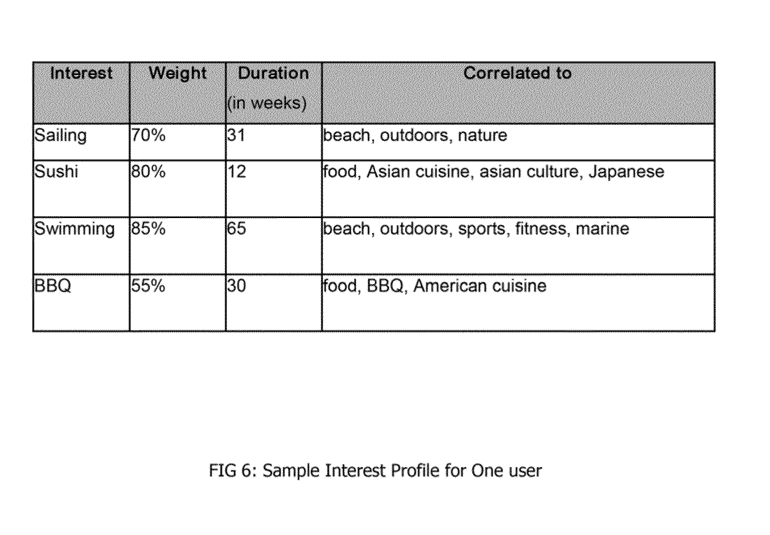

FIG. 6 illustrates an exemplary table showing a sample interest profile of a user. In one embodiment an interest 605 is listed. In one embodiment weight 610 is accorded to interest 605. In one embodiment duration 615 is determined based on a time period. In this embodiment, for example, duration 615 is measured in weeks. In one embodiment, a correlated profile 620 is created based on interest 605, weight 610, and interests.

### The Web APIs for Putting Interests

In one embodiment, an application that wishes to build an interest graph and use it for personalization and targeting has to first input its users activities to the interest graph engine via web APIs. In an embodiment, this may be a continual activity. The frequency of this input is a determining factor in the accuracy of the interest profile of each user and the resulting interest graph of the application's community of users.

In one embodiment, web APIs accessible from the application (e.g., via issuing HTTPs POST requests as follows:
a. postUserPhotoUpload (appid, userid, media url, optional social_network_id)
b. postUserVideoUpload (appid, userid, media url, optional SocialNetwork_id)
c. postUserPhotoLike (appid, userid, media url, optional SocialNetwork_id)
d. postUserPhotoComment (appid, userid, media url, text-comment, optional SocialNetwork_id)
e. postUserVideoLike (appid, userid, media url, optional SocialNetwork_id)
f. postUserVideoComment (appid, userid, media url, text-comment optional SocialNetwork_id)
g. postUserCheckin (appid, userid, lat, long, venue-id, venue-metadata, optional SocialNetwork_id)
h. postUserTextComment (appid, userid, text-comment, optional SocialNetwork_id)
i. postUserLikeText (appid, userid, text-comment, optional SocialNetwork_id)
j. postUserBrandPageLike (appid, userid, brandpage-url, optional SocialNetwork_id)
k. postUserBrandPageComment (appid, userid, brandpage-url, text-comment, optional SocialNetwork_id)
   Algorithm for Computing Interests Based on Activities Gathered from One Mobile application
   For the purpose of one embodiment, a mobile activity in the exemplary implementation can be any one of the actions listed in the itemized list above (a-k)

### Algorithm 1.

1. For each new user activity T received from application
2. Populate signal attributes for the activity T based on noise, frequency, etc.
3. Infer interest list I from user activity T
4. filter out the noise in inferred interests I
5. Parse the interest graph for conflicting interests
Re-calibrate the interest weights of all interests in the user interest-profile in DB
Computing Interests Based on Activity Gathered from Multiple N Applications Using a Common Social Network ID

In one embodiment of the invention, multiple mobile applications A1 . . . AN all share the same login system via a common major social network such as, but not limited to, Facebook, Twitter, and Foursquare. In an embodiment, the interest recognition platform aggregates the user's activities across all such mobile applications since said user is using the same identity namely that social network id. Therefore, for example, the targeting profile used in Application A1 will benefit from interests inferred from activities on applications A2, A3 . . . An and vice versa.

### Algorithm 2.

1. for each application A_i i=1, i++; i<=N
2. For each new user activity T received from application A_i (such as photo upload, check-in, a Like, etc) marked with the user's Social Network id SN_id
3. Populate signal attributes for the activity of user SN_id based on noise, frequency, etc.
4. Infer interest list I from user SN_id activity T
5. filter out the noise in inferred interests I
6. Parse the interest graph for conflicting interests
   Re-calibrate the interest weights of interest profile of user SN_id
   As depicted in the flowchart of FIG. 4 herein.

To explain step 5 above further, an example and description of the following algorithmic steps are provided:

a. User A checked in for 5 times at Vegetarian restaurants during the last 5 days, whereas in her current interest profile there is a relatively strong interest in BBQ.

b. These are clearly conflicting interests. The algorithm performs the Conflicting Interests Resolution & Adjust Function in this particular case:

```
1. Function ResolveConflictAdjustWeights (Old-interest, New-interest)
2. Let the current weight of old interest (in the example BBQ) be W_old
3. Let the duration of old interest be D_old
4. Let the current weight of new interest be W_new
5. Let the duration of new interest be D_new
6. if D_old > 10*D_new // new interest maybe transient
7.  then {
    a. D_old = D_old − D_new
    b. W_old = W_old − 10
    c. W_new = W_new +10
      }
8.  else { // old conflicting interest isn't entrenched so faster decay
    a. D_old = D_old − 2*D_new
    b. W_old = W_old − 20
    c. W_new = W_new +20
  }
9. return updated interest-profile of interests and weights
```

In other words, in this example, if user A has been interested in BBQ for a long period, say 30 weeks or longer, and her new interest in vegetarian food is only 1 week old, both interests will continue to be listed in her profile. However, the weight of BBQ will continue to be decreased as her interests in vegetarian restaurants gets increasingly stronger weight. This gradual decay process continues over time until BBQ is weighted at 0, when she becomes strictly vegetarian if she reaches that level.

Moreover, an exemplary object of one exemplary embodiment of the present invention is to provide a method for presenting personalized highly relevant advertising, rewards and deals through an interactive web application or service via various computing means device based systems (i.e. but not limited to desktop, mobile devices, tablets, augmented reality devices, wearable mobile devices, advanced eyewear and/or ear/headwear sets coupled or stand alone with augmented reality devices, etc).

An additional exemplary embodiment of the invention provides the ability for personalized advertising, rewards or offers in an interactive service to enable the presentation of advertising, reward or offer on an accurate targeting profile from inferred user actions and activities and integrated with presentation of service applications through aforementioned computing systems. In another exemplary embodiment, there is an ability to minimize the potential for interference between the supply of interactive-service applications and advertising.

As a result of implementation of an embodiment of the present invention, an ability for personalized advertising in an interactive service can occur with the method, thus in one embodiment, enabling the advertising presented to be highly personalized to the user in order to increase the likelihood the advertising, reward or offer be of interest to the user, and therefore will be clicked on, redeemed or transacted.

In one exemplary embodiment, the method includes steps for organizing advertising/reward/offer and applications as objects that collectively include presentation data and executable program instructions for generating the advertising and applications at the reception system. In accordance with one exemplary embodiment of the method, advertising and application objects are selectively distributed in the service network in accordance with a predetermined plan based on the likelihood the applications and advertising will be called by the respective user reception systems.

In one exemplary embodiment, aspects of the present invention include a system for supplying personalization and targeting profiles of users of a mobile web-based application comprising of several exemplary components. For example, in one embodiment, a component includes a personalization targeting server cluster, which may include more than one server. In one embodiment, one or more servers may host software method for inferring user interests based on photo and videos, check-ins, user preferences (such as likes and +1s) and textual comments. In one exemplary embodiment, a database storing user interest attributes and interest profiles and in another exemplary embodiment, web APIs for receiving user activity from the application server. In one exemplary embodiment, a mobile application client running on a mobile computing means device that connects with its own mobile application service. In one exemplary embodiment, a mobile application server for said mobile application hosting its user data and user activities on said mobile application that posts such data to the targeting server. The mobile application server may connects with multiple advertising networks to receive advertisements, rewards or commercial offers. In one exemplary embodiment, the mobile application server calls web APIs to upload its user activities with said personalization and targeting server. In one exemplary embodiment, the mobile application server calls web API to download the targeting profile of a particular user which it uses to filter ads, rewards and offers and sends highest relevance one its mobile application client. In one exemplary embodiment, the mobile application client displays said advertisements, rewards, or commercial offers to said user and reports any click or reward redemption back to its mobile application server. In one exemplary embodiment, the mobile application server reports click or reward redemption back to said personalization and targeting server.

Although a specific embodiment of the present invention has been described, it will be understood by those of skill in the art they are not intended to be exhaustive or to limit the invention to the precise forms disclosed and obviously many modifications and variations are possible in view of the above teachings, including equivalents. Accordingly, it is to be understood that the invention is not to be limited by the specific illustrated embodiments, but only by the scope of the appended claims.

1. A method for supplying personalization and targeting profiles of users of a web-based application via a computing device comprising:
compiling data and activities concerning a respective community of users of said application;
establishing interest profiles and interest graph for said users based on said compiled data;
filtering noise and calibrating said compiled data;
structuring said compiled data as a list of weighted interests;
providing a weighted interest profile, wherein said weighted interest profile includes a personalization and targeting profile, based on said weighted interest list to said application; and
displaying additional information to said user, wherein said additional information is based on said personalization and targeting profile.

2. The method of claim 1 wherein said personalization and targeting profile includes location data.

3. The method of claim 1 wherein said personalization and targeting profile includes interests inferred from photo uploads.

4. The method of claim 1 wherein said personalization and targeting profile includes interests inferred from video uploads.

5. The method of claim 1 wherein said personalization and targeting profile includes interests inferred from analysis of textual comments.

6. The method of claim 1 wherein said personalization and targeting profile includes interests inferred from social attributes of a photo of another.

7. The method of claim 1 wherein said personalization and targeting profile includes interests inferred from becoming a fan of a brand-sponsored page or property in the application or game.

8. The method of claim 1 wherein communication between said application and said personalization and targeting system occurs on a server side.

9. The method of claim 1 as enacted by a computing device means for supplying
personalization and targeting profiles of users of an augmented reality web-based application wherein said augmented reality application uses said targeting profile to filter advertisement or commercial offers for relevance and only display the most relevant advertisement or commercial offer to the user.

10. A method for supplying personalization and targeting profiles of users of multiple web-based applications via a computing device means comprising:
compiling data and activities concerning a respective community of users of multiple applications all of said users who each use one common user id and all of whom share said activities to a common web-based API service;
establishing interest profiles and interest graph for said users based on said compiled data;
filtering noise and calibrating said compiled data;
structuring said compiled data as a list of weighted interests;
providing a weighted interest profile, wherein said weighted interest profile includes a personalization and targeting profile to said web-based application; and
displaying additional information to said user wherein said additional information is based on said personalization and targeting profile.

11. The method of claim 10 as enacted by a computing device means for supplying personalization and targeting profiles of users of mobile web-based applications wherein said mobile application uses said targeting profile to filter advertisements for relevance and displays the highest relevance advertisement to the user.

12. The method of claim 10 as enacted by a computing device means for supplying personalization and targeting profiles of users of mobile web-based applications wherein said mobile application uses said targeting profile to display personalized recommendations to the user.

13. The method of claim 10 as enacted by a computing device means for supplying personalization and targeting profiles of users of mobile web-based applications wherein the user is given the option to edit their interest profile.

14. A system for supplying personalization and targeting profiles of users of a mobile web-based application comprising:
one or more servers hosting a software method for inferring user interests based on a multiplicity of mobile user activity data, a database storing user interest attributes and interest profiles and web APIs for receiving user activity from the application server;
a mobile application client running on a mobile computing device that connects with a mobile application service; and
a mobile application server for said mobile application hosting its user data and user activities on said mobile application that posts such data to the targeting server.

15. The system of claim 14 wherein said mobile application server connects with at least one advertising networks to receive commercial offers.

16. The system of claim 14 wherein said mobile application server calls web APIs to upload its user activities with said personalization and targeting server.

17. The system of claim 14 wherein said mobile application server calls web API to download the targeting profile of a particular user which it uses to filter advertisements or commercial offers and sends the most relevant to said mobile application client.

18. The system of claim 14 wherein said mobile application client displays said advertisements or commercial offers to said user and reports any click, reward redemption, or commercial transaction back to said mobile application server.

19. The system of claim 14 wherein said mobile application server reports click or reward redemption back to said personalization and targeting server to be used for reinforcing said interest in the user's interest profile.
